(19) United States
(12) Patent Application Publication
(10) Pub. No.: US 2010/0233444 A1
(43) Pub. Date: Sep. 16, 2010

(54) Composition,article, its manufacture and use

(76) Inventors: Peter Andrew Reath Bennett, Leeds (GB); Roberto Massimo Allegrini, San Felice Segrate (IT)

Correspondence Address: NIXON & VANDERHYE, PC, 901 NORTH GLEBE ROAD, 11TH FLOOR, ARLINGTON, VA, 22203, US

(21) Appl. No.: 12/308,653

(22) PCT Filed: Jul. 2, 2007
(86) PCT No.: PCT/GB2007/002476

§ 371 Date: Mar. 19, 2009

(30) Foreign Application Priority Data
Jun. 30, 2006 (GB) 0612984.5

(51) Int. Cl. B32B 3/10; G03C 1/00; C07F 9/02

(52) U.S. Cl. 428/195.1; 430/270.1; 568/13; 568/16; 556/404

(57) ABSTRACT

A composition comprising a polymer which contains hydroxyl groups, the composition being suitable as a coating for an IR-imagable lithographic precursor, the composition comprising one or more agent(s) which: a) absorbs IR radiation of wavelength greater than 800 nm and consequently generates heat; b) functions as an insolubiliser which inhibits dissolution of non-imaged regions of the coating in a developer but permits dissolution of imaged regions during development; and c) improves the inhibition to dissolution of the non-imaged regions and/or the dissolution of the imaged regions so as to improve the dissolution contrast ratio (DCR) of the non-imaged/imaged regions; wherein the agent which performs function c) comprises a moiety which has hydrophobic and ionic character. Such a composition can show excellent selectivity as regards dissolution rates in developer, as between the imaged and non-imaged areas, whilst the energy needed to achieve this differentiation (or “operating speed”) is not comprised.

The present invention relates to an imagable composition, to a lithographic printing form precursor (which means herein an unimaged printing form, bearing a to-be-imaged coating over one face), to its manufacture and to its use in making a printing form (which means herein a printing form with a ready-to print coating which denotes—either in a positive or negative form—the image to be printed). A printing form herein commonly means a printing plate or an alternative printing surface.

The invention seeks to improve lithographic printing form precursors, especially positive working lithographic printing form precursors. Such precursors have developer soluble polymeric coatings. In conventional positive working lithographic printing form precursors having as coating alkali soluble polymers, for example novolac resins, and naphthoquinone diazides (NQD) moieties, regions of the coating unexposed to ultra-violet (UV), radiation have a very low dissolution rate in conventional alkaline developing fluids, because NQD is a strong dissolution inhibitor. This means that it inhibits—prevents or retards—the dissolution of the coating in such developing fluids. The exposed areas of the coating may undergo a number, of chemical and physical changes (which may include any or all of volume, polarity, conformation, chemical structure, heat of reaction, hydrogen bonding, and hydrolysis) which may bring about a dramatic change in their dissolution rate in the alkali developer. The process provides huge processing contrast between exposed and unexposed regions, typically greater than 100:1 for a given exposure energy and development conditions.

In many thermal systems (for example Thermal Computer-to-Plate (CTP) positive systems), the only changes taking place during exposure are those caused by the heat supplied (typically by IR lasers acting on IR absorbers in the coatings). The heat causes physical changes to the tertiary structure; for example causing disruption of the hydrogen bonded structure. This results in a lower processing contrast as between exposed and unexposed regions, typically 10-20:1 for a given exposure energy and development conditions. In order to achieve commercially viable positive working printing form precursors the rate of dissolution of exposed regions of coating in the developer has to be fairly high and the processing contrast should desirably be high. Sufficient coating must remain for printing after development, and excess coating dissolution shortens the life of processing chemicals dramatically. This necessitates the application of higher exposure levels to supply energy to break down the developer resistant coating. This limits productivity for the printer. An object, then, is the use of lower exposure levels to achieve comparable developer resistance; or better developer resistance for the same exposure energy.

U.S. Pat. No. 5,554,664 describes an energy activatable salt which comprises a cation (as defined) and an anion, which may be a bis- or tris-(highly fluorinated alkylsulfonyl)methide or a bis- or tris-(fluorinated arylsulfonyl)methide. Imaging is by e-beam, or UV or visible radiation (about 200 nm to 800 nm).

U.S. Pat. No. 6,841,333 describes photoacid generators having fluorinated anions, for example PFC, SbF₆⁻, CF₃SO₃⁻, C₄H₉SO₃⁻, and C₈H₁₇SO₃⁻. The anions are said to provide high acid strength and very strong catalytic activity; to give fast photo speeds (in positive resists) and fast cure speeds (in negative resists); and to be environmentally benign. Imaging is by e-beam, ion beam, X-ray, extreme UV, deep-UV, mid-UV, near-UV or visible radiation.

U.S. Pat. No. 6,358,665 describes radiation sensitive compositions comprising a hydroxystyrene resin and an onium salt precursor which generates a fluorinated alkanesulfonic acid as a photoacid generator. The photoacid generator is a sulfonium or iodonium salt of a fluorinated alkane sulfonic acid; the anion being CF₃CHFCF₂SO₃⁻ or CF₃CF₂CF₂CF₂SO₃⁻. Imaging may use metal halide lamps, carbon arc lamps, xenon lamps and mercury vapour lamps.

GB 1245924 discloses the image-wise application of heat to coatings of phenolic resins, and of many other polymers, to increase the solubility of the coatings in the exposed areas compared with the unexposed areas. However, whilst NQDs and other inhibitors which reduce the solubility of the coatings to developing fluids are described a high amount of exposure energy is required to render the exposed areas soluble.

U.S. Pat. No. 4,708,925 describes the use of onium salts to impart solvent resistance to a phenolic resin. The onium salts inhibit the dissolution of a coating of the phenolic resin in a developer. However once exposed to infra-red radiation this inhibiting effect is lost. In this case, the release of acids on exposure by utilising proto-acidic anions (i.e. latent Bronsted acids) to the onium cation assists in making the exposed regions of the coating more developer soluble for the same amount of exposure energy. This technology can also be utilised for a negative plate by heating after laser exposure and before development, followed by flood UV exposure and development. In this patent numerous anions and cations are disclosed. The anions include hexafluorophosphate, perfluoroalkylsulfonium, CF₃COO⁻, SbF₆⁻ and BF₄⁻.

The technical proposals of both of these patents also suffer from a problem related to stability, that is: after a coating has been prepared and is promptly exposed, it requires an amount of exposure energy of X mJ/cm² to achieve best results, but after 1 week of standing it requires Y mJ/cm² where Y is a number greater than X.

The value of Y is affected by almost every component that is included in a phenolic resin formulation and by every process used to prepare the lithographic printing form precursor. This gives the printer an almost impossible task in setting up for a print run; essentially when Y is significantly greater than X the technical proposals of both of these patents are commercially impractical.

U.S. Pat. No. 6,461,795 and U.S. Pat. No. 6,706,466 acknowledge this stability issue and describe a process for overcoming it by subjecting the coated precursor to a mild heat treatment of between 40 and 90° C. for at least 4 hours.

U.S. Pat. No. 5,340,699 discloses that onium compounds could be utilised for creating a positive or negative working printing plate with UV or IR radiation. In this case the positively exposed plate can be utilised directly or is subjected to a substantial heating process prior to development which causes a cross-linking of the exposed areas brought about by the generation of acid from an onium latent Bronsted acid which is present along with a resole resin. That is, the process is negative overall. The constraint of relative developer solubility pre- and post-exposure compared to energy demand exists in these systems too and in the positive version, stability is also an issue.

To counter the problems of processing contrast, pre- to post-exposure, and energy demand, EP 1024963A employs a silicone polymer as a coating solution component and proposes that this migrates to the surface of the coating as it dries. It is believed that, since the silicone' repels aqueous solutions the unexposed portions of the coating have enhanced resistance to developer fluids. In the regions where the coating has been heated, the surface becomes disrupted and a developer fluid can quickly break through to the bulk of the exposed regions of the coating. This allows either a lower energy demand coating to be formulated, which has similar developer properties to a reference without the silicone polymer, or the same energy demand with better developer resistance characteristics. A problem with this technology, however, is that at the high levels (3-6%) disclosed for the silicone polymer loading in the liquid composition the silicone polymers have an instability effect in such coatings. In this context it should be noted that silicones in polymeric coatings (employed for example as aids to levelling and film cosmetic appearance generally (U.S. Pat. No. 4,510,227)) are normally employed in amounts of substantially less than 1%. At the 3-6% level of EP 1024963A incompatibility results in inhomogeneity in the dried coating with the associated presence of white sports, or coating voids, due, we believe, to areas which are underprotected as a result of the asymmetric distribution of the silicone polymer.

Another solution proposed having regard to the contrast and energy demand issue is the employment of two or more layers making up the coating, especially of different compositions. Here, an under-layer, next to or near to the substrate, should be of higher developer solubility than an over-layer, for example a surface or outer layer, as described in U.S. Pat. No. 6,153,353 and U.S. Pat. No. 6,352,812. In, such embodiments, when the coating is positively exposed the whole coating in the unexposed areas has a low dissolution rate whilst in the exposed areas it develops at a typical rate. Once the imaged over-layer has been dissolved away, the under-layer, which has a very high dissolution rate in developer, dissolves very quickly. In total, the exposed area has developed much faster than the unexposed regions and the processing contrast for the same energy is improved. There are, however, some significant cost problems (capital and revenue) with this approach. One is the need for two coating, drying and inspecting machines; another is the increased handling needed, leading to increased labour costs. Another problem is a higher level of coating quality faults. Coating quality faults are inevitable in any coating operation. If, for example, the scrap generated from a single coating is 3% (a typical value), a two layer system is expected to increase the scrap generated to about 6%. Further, these systems based on positive phenolic/novolac coatings remain are not adequately stable over time.

In summary, there is a need for a radiation sensitive composition which, when coated onto a substrate to form, a lithographic printing form precursor, has regions which when exposed to imaging energy have a very high rate of developer solubility whilst having high developer resistance in regions which are not exposed to imaging energy; without compromising—that is, significantly increasing—the practical exposure energy required (in other words without reducing the “speed” of the printing form precursor). A primary aim is to improve “single layer” coatings. However, the improvement of coatings formed of two or more layers is not excluded.

In accordance with a first aspect of the present invention there is provided a composition comprising a polymer which contains hydroxyl groups, the composition being suitable as a coating for an IR-imagable lithographic precursor, the composition comprising one or more agent(s) which:

a) absorbs IR radiation of wavelength greater than 800 nm and consequently generates heat;
b) functions as an insolubiliser which inhibits dissolution of non-imaged regions of the coating in a developer but permits dissolution of imaged regions during development; and
c) improves the inhibition to dissolution of the non-imaged regions and/or the dissolution of the imaged regions so as to improve the dissolution contrast ratio (DCR) of the non-imaged/imaged regions; wherein the agent which performs function c) comprises a moiety which has ionic, and, preferably, hydrophobic character.

In a preferred composition of the first aspect the agent which functions as an insolubiliser does not decompose on absorption of the IR radiation. Preferably such an agent which functions as an insolubiliser which does not decompose on absorption of the IR radiation regains its insolubilisation effect with time, after irradiation has caused its insolubilisation effect to be lost.

Preferably the agent absorbs IR radiation in the wavelength range 805 nm to 1500 nm, preferably 805 to 1250 nm.

The hydroxyl groups may include hydroxyl groups carried directly on the backbone of the respective polymer; Alternatively or additionally, the hydroxyl groups may include hydroxyl groups which are part of a larger pendant group, for example a carboxylic acid group (—COOH) or its salts, or a sulphonic acid group (—SO₃H), or an alcohol (—CH₂OH) or a mixture thereof.

Preferably the polymer is soluble or dispersible in water or aqueous solutions after imaging, the solution having a pH in excess of 5, preferably in excess of 7, and, most preferably in excess of 8.5.

The polymer is suitably a phenolic polymer, for example a resole or a novolac resin; or a polyvinylphenol (e.g. a homo- or heteropolymer of hydroxystyrene). Most preferably it is a novolac resin.

The agent(s) which perform(s) functions a), b) and c) may be individual compounds or two or three such functions may be performed by one compound. Thus one compound may perform functions a) and b); or one compound may perform functions a) and c); or one compound may perform functions b) and c). Or one compound may perform functions a), b), and c).

The agents which perform functions a), b) and c) may be individual compounds or may be carried as dissociable pendant groups by the polymer. In principle the agents performing functions a), b) and c) could all be carried by the polymer.

Preferably the imagable lithographic precursor is a precursor for a printing form, mask used in printing, or electronic part.

We have found that by use of an agent performing the function c), to improve the DCR, we obtain excellent selectivity as regards dissolution rates in developer, as between the imaged and non-imaged areas, whilst the energy needed to achieve this differentiation (or “operating speed”) is not substantially compromised.

Preferably imaging is carried out using a liquid developer but processless operation is in principle possible (for example on-press in the case of a printing form).

Preferably the composition is positive working. Thus, in such embodiments we obtain excellent selectivity as regards dissolution rates in developer, as between the imaged, soluble, areas and non-imaged, developer resistant areas (insolubilising effect being lost on imaging); whilst the energy needed to achieve this differentiation is not compromised).

Preferred compositions of the invention form coatings which may be handled without damage under ordinary indoor lighting conditions, including when ambient natural light is transmitted indoors through windows and under standard white room lighting. Preferably UV safelighting is not needed.

A desirable additional component of the composition of the first aspect is cellulose acetophthalate (CAHPh). CAHPh is particularly useful at rendering such compositions resistant to solvents used in printing thereby increasing the run length capability of said coatings in the presence of solvents (including aggressive solvents). CAHPh is a desirable addition to prior compositions that employ siloxanes to help developer resistance properties but only at a modest level, because of physical incompatibility between siloxanes and CAHPh. In the compositions of the present invention siloxanes are preferably not present. In such embodiments CAHPh can be added at higher level, for example 2-10% wt/wt, preferably 3-8%.

Preferred classes of agents will now be described.

In general the hydrophobic property may come from the cation, or from the anion, or from both.

Preferably the agent comprises an onium cation or a carbocation. Examples of onium cations include a carbonium, ammonium, diazonium, sulphonium, sulphoxonium, phosphonium or iodonium cation. An example of a carbocation is a carbenium cation. Carbenium, ammonium, iodonium and, especially, phosphonium cations are preferred. The onium or carbocation moiety may be pendent from the polymer but is preferably in the form of one or more individual compound(s).

The onium or carbocation moiety may have alkyl or aryl functional groups attached to the inorganic centre (or carbon centre in the case of the carbonium ion).

The onium cation preferably performs the insolubilisation function b) above. It is ionic and may be hydrophobic, and also perform function c) above. In such an embodiment it preferably has at least one of the following hydrophobic-promoting means:
at least one hydrophobic alkyl group (preferably at least two or at least three or at least four such groups) having at least 6 carbon atoms; preferably 6-24 carbon atoms, especially 8-16 carbon atoms;
at least one hydrophobic fluoroalkyl group (preferably at least two or at least three or least four such groups) having at least 1 carbon atom; preferably at least 2, preferably 1-12, most preferably 2-8; the or each fluoroalkyl group preferably being a perfluoroalkyl group;
at least one hydrophobic silicon-containing group, for example a silyl group of formula SiₙR₂ₙ₊₁⁻ where each R is independently a hydrogen or a C₁₋₄ alkyl group and n is a number from 1 to 8; and
at least one aryl, especially phenyl, group (preferably at least two or at least three or at least four aryl groups) which is optionally substituted by at least 1, 2 or 3 hydrophobic moieties selected from an alkyl group having up to 24 carbon atoms, optionally a hydrophobic alkyl group (as just defined), a fluorine atom, a hydrophobic fluoroalkyl group (as just defined) and a hydrophobic silicon-containing group (as just defined).

A preferred phosphonium cation may have the following formula:

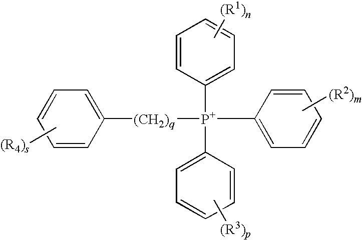

where:
n represents 0 or an integer in the range 1-5;
R¹ represents an hydrogen atom or a fluorine atom or a C₁₋₂₄ alkyl group or a C₁₋₁₂ fluoroalkyl group; and where there is more than one group R¹ they may be the same or different;
m represents 0 or an integer in the range 1-5;
R² represents an hydrogen atom or a fluorine atom or a C₁₋₂₄ alkyl group or a C₁₋₁₂ fluoroalkyl group; and where there is more than one group R² they may be the same or different;
p represents 0 or an integer in the range 1-5;
R³ represents an hydrogen atom or a fluorine atom or a C₁₋₂₄ alkyl group or a C₃₋₁₂ fluoroalkyl group; and where there is more than one group R³ they may be the same or different;
q is an integer of between 1 and 4;
s represents 0 or an integer in the range 1-5; and
R⁴ represents a hydrogen atom or a fluorine atom or a C₁₋₂₄ alkyl group or a C₁₋₁₂ fluoroalkyl group; and where there is more than one group R⁴ they may be the same or different.

Preferred alkyl groups R¹, R² and R³ contain 1-16 carbon atoms, preferably 1-12 carbon atoms.

Preferred fluoroalkyl groups R¹, R² and R³ are substantially fully substituted by fluorine atoms (that is, R¹, R² and R³ are preferably perfluoroalkyl groups).

Preferred fluoroalkyl groups are C₁₋₈ fluoroalkyl groups, preferably trifluoromethyl or perfluoroheptyl.

In a preferred embodiment n is 5 and each R¹ is hydrogen; or each R¹ is fluorine; or each R¹ is trifluoromethyl.

In a preferred embodiment n is 5 and each R² is hydrogen; or each R² is fluorine; or each R² is trifluoromethyl.

In a preferred embodiment n is 5 and each R³ is hydrogen; or each R³ is fluorine; or each R³ is trifluoromethyl.

In a preferred embodiment n, m and p are all 5 and each R¹, R² and R³ is hydrogen.

In another preferred embodiment n, m and p are all 5 and each R¹, R² and R³ is fluorine.

In another preferred embodiment n, m and p are all 5 and each R¹, R² and R³ is trifluoromethyl.

In a preferred embodiment n is 1 and R¹ is a perfluoro C₄₋₈ alkyl group, preferably perfluoroheptyl, preferably carried at the para position relative to the P⁺ atom.

In a preferred embodiment m is 1 and R² is a perfluoro C₄₋₈ alkyl group, preferably perfluoroheptyl, preferably carried at the para position.

In a preferred embodiment p is 1 and R³ is a perfluoro C₄₋₈ alkyl group, preferably perfluoroheptyl, preferably carried at the para position.

In a preferred embodiment n, m and p are all 1 and R¹, R² and R³ are all perfluoro C₄₋₈ alkyl, and preferably all perfluoroheptyl; the respective fluoroalkyl groups preferably being carried at the para positions.

Preferably R⁴ is a fluorine atom, a C₁₋₂₄alkyl group or C₁₋₁₂ fluoroalkyl group. Preferably s is 1, 2 or 3.

Especially preferred R⁴ are fluorine and trifluoromethyl. In an especially preferred embodiment, s is 1 and R⁴ is trifluoromethyl, with the substituent at the para-position.
Suitably q is an integer from 1 to 4; especially 1.

An especially preferred hydrophobic cation is (m, m-bis(trifluoromethyl)benzyl)triphenylphosphonium.

Further examples of hydrophobic phosphonium cations include the following:

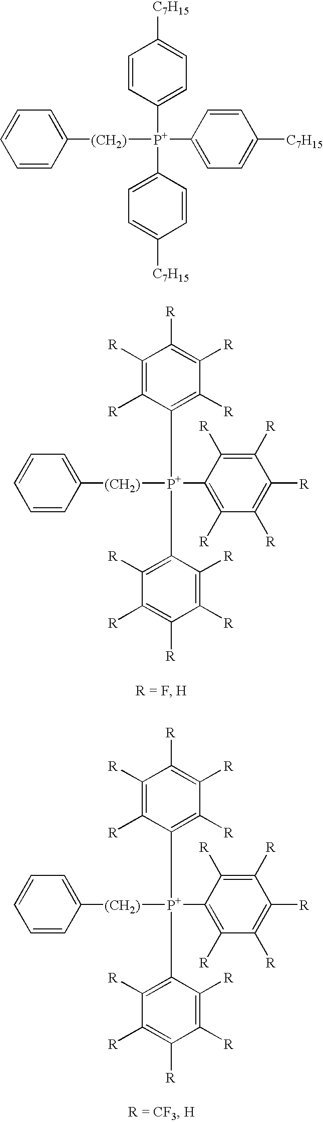

Examples of silylated cations include the following:

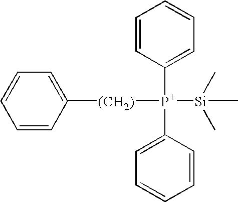

The cation may suitably be a dye cation, such as a triarylmethane cation (as in the case of, for example, crystal violet, FlexoBlue 636 or ethyl violet); a cyanine dye, for example S0094 or S0253 from FEW Chemie; a thiazine dye, for example methylene blue; or an oxazine dye, for example Nile Blue. These may be modified for hydrophobicity in the manner described above, for example by exchanging an alkyl functionality to a longer chain alkyl functionality or a fluoroalkyl functionality. For example, crystal violet has three dimethylamino functionalities—a similar but more hydrophobic dye material could be prepared that has three di-(trifluoromethyl)amino functionalities in their place. Like wise ethyl violet has three diethylamino groups—a similar but more hydrophobic dye could be prepared that has three di-(pentafluoroethyl)amino groups in their place.

The preceding passages discussed possible hydrophobic-promoting modification of cations but in fact in accordance with this invention unmodified cations are preferred, and it is preferred to modify the anions.

Examples of preferred unmodified phosphonium cations for use in this invention may include diphenylbenzylphosphonium and, especially, triphenylbenzylphosphonium, and triarylmethane dyes, notably crystal violet.

Preferably the anion is the conjugate base of an acid having a pKa of less than 15, preferably less than 12, more preferably less than 9, more preferably less than 6.

Preferably the anion is hydrophobic, and so may perform function c) above. Preferably it is made so by the presence of fluorine, silicon, fatty alkyl, or aryl functionality.

In such an embodiment in which the anion is hydrophobic, it preferably has at least one of the following hydrophobic-promoting means:
at least one hydrophobic alkyl group (preferably at least two or at least three or at least four such groups) having at least 6 carbon atoms; preferably 6-24 carbon atoms, especially 8-16 carbon atoms;
at least one hydrophobic fluoroalkyl group (preferably at least two or at least three or at least four such groups) having at least 1 carbon atom; preferably at least 2, preferably 1-20, most preferably 2-10; the or each fluoroalkyl group preferably being a perfluoroalkyl group;
at least one hydrophobic silicon-containing group, for example a siloxane group or a silyl group of formula SiₙR₂ₙ₊₁⁻ where each R is independently a hydrogen or a C₁₋₄ alkyl group and n is a number from 1 to 8; and
at least one aryl, especially phenyl, group (preferably at least two or at least three or at least four aryl groups) which is optionally substituted by at least 1, 2 or 3 hydrophobic moieties selected from an alkyl group having up to 24 carbon atoms, optionally a hydrophobic alkyl group (as just defined), a fluorine atom, a hydrophobic fluoroalkyl group (as just defined) and a hydrophobic silicon-containing group (as just defined).

An example includes a silyl counterion of onium salts or carbocation, for example as follows:

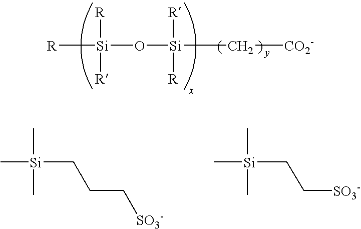

Where: in the first compound each group R and R¹ independently represents an optionally substituted C(1-20) alkyl or optionally substituted aryl group (especially optionally substituted phenyl), x is an integer, and y is an integer from 1 to 8; and wherein in the second and third compounds the chain between the silicon atom and the sulfonate moiety has 1-20 carbon atoms in total, preferably 3-12.

Preferably any anion, including those shown above, may be terminated by one of the groups —O₃S—, —O₂C—, —O₂S—, H₂PO₄—, —HPO₃

Examples of suitable hydrophobic anions having aryl groups include xylene sulfonates, mesitylene sulphonates and, especially, tosylates.

Certain cations and anions described and defined herein are new and are further defined as follows:

(1) Compounds having a novel or known anion and a cation having:
at least one hydrophobic alkyl group as defined above;
at least one hydrophobic fluoroalkyl group as defined above;
at least one hydrophobic silicon-containing group as defined above; and
at least one aryl group which is optionally substituted by at least 1, 2 or 3 moieties selected from a fluorine atom or an alkyl, fluoroalkyl or silicon-containing group.

In such embodiments the anion can be novel (as defined below) or it may be known in itself; for example CF₃COO⁻, SbF₆⁻ BF₄⁻, PF₆⁻, SbF₆⁻, CF₃SO₃⁻, C₈H₁₇SO₃⁻ CF₃CHFCF₂SO₃⁻ and CF₃CF₂CF₂CF₂SO₃⁻.

A preferred cation is a fluorinated phosphonium cation, such as fluorinated BnPh₃P⁺, preferably (di-CF₃)BnPh₃p⁺.

(2) Compounds having a novel or known cation and an anion having:
at least one hydrophobic alkyl group as defined above;
at least one hydrophobic silicon-containing group as defined above; and
at least one aryl group which is optionally substituted by at least 1, 2 or 3 moieties selected from a fluorine atom, or alkyl, fluoroalkyl or silicon-containing group as defined above.

As is conventional the symbol Bn used herein denotes a benzyl group —CH₂—Ph.

In such embodiments the cation can be novel (as defined above) or it may be known in itself; for example it may be a known phosphonium salt such as (Ph)₃BnP⁺, or (Ph)₂I⁺ or may be a triarylmethane dye such as crystal violet ethyl violet.

Interesting novel compounds may include phosphonium cations such as (Ph)₃BnP⁺, hydrophobically modified or conventional, having alkyl- or aryl-carboxylate or sulphonate anions made hydrophobic by the presence of fluorine, silicon, fatty alkyl, or aryl moieties, as defined above.

Interesting novel compounds may include salts of triarylmethane dyes such as crystal violet and ethyl violet, hydrophobically modified or conventional, and carboxylate or sulphonate anions made hydrophobic by the presence of fluorine, silicon, fatty alkyl, or aryl moieties, as defined above.

Novel compounds represent a second aspect of the present invention.

We make no claims as novel compounds of this invention of the following:
the fluorinated methide or imide compounds disclosed in U.S. Pat. No. 5,554,664, as more precisely defined therein.
the compounds disclosed in U.S. Pat. No. 6,841,333 having segmented hydrocarbon-fluorocarbon-sulfonate anions, as more precisely defined therein.
the compounds disclosed in U.S. Pat. No. 6,358,665, being sulfonium or iodonium salts of a fluorinated alkane sulfonic acid, as more precisely defined therein.

It should be noted however that since the use of such compounds in the present invention differs from that disclosed in U.S. Pat. No. 5,554,664, U.S. Pat. No. 6,841,333 and U.S. Pat. No. 6,358,665, such use is regarded as an aspect of the present invention.

In accordance with the third aspect of the present invention there is provided a process for the preparation of novel compounds, claimed in the second aspect. When the compound is an onium salt the reaction is suitably a nucleophilic substitution, suitably under normal conditions. By way of illustration, processes for the preparation of phosphonium salts are outlined as follows:

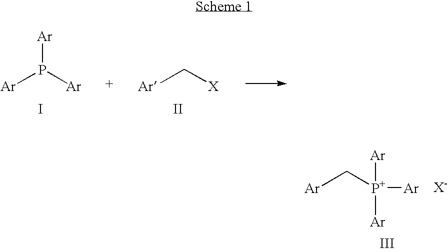

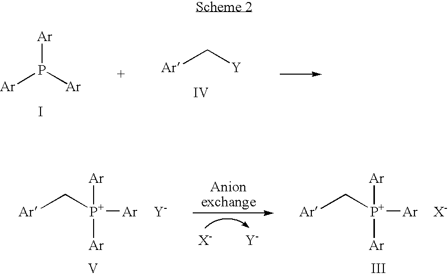

A process for the preparation of compound of general formula III is described in Scheme 1 and 2, in which:
Compound I is a triarylphosphine or any of its stable salts. Ar is an aryl or hetaroayl group; preferred groups are phenyl, alkyl substituted phenyl, alkoxy substituted phenyl, furyl, α- and β-naphthyl. Each Ar may be the same or different and may be optionally substituted with any of the hydrophobic-promoting moieties as defined above;
Ar′ in compound II is an aryl or hetaryl group, equal or different to Ar; preferred groups are phenyl, alkyl substituted phenyl, alkoxy substituted phenyl, carboxyphenyl, alkoxycarbonylphenyl, α- and β-naphthyl. Ar′ may be optionally substituted with any of the hydrophobic-promoted moieties as defined above.
X is any of the leaving groups usually employed by those skilled in the art as common leaving groups for nucleophilic substitution reactions. Preferred groups for the process reported in Scheme 1 are: OH, OAc, OOC(CF₂)₀₋₂₀CF₃, O₃S(CF₂)₀₋₂₀CF₃. Preferred groups for the process reported in Scheme 2 are: F, Cl, Br, I, OH, OAc, C₁-C₂₀ alkanesulfonate, benzenesulfonate and mono- or poly-substituted arylsulfonates (expressly including substitution with one or more of the following preferred groups: CH₃, NO₂, F, Cl, Br, I, O-Alkyl, or any combination of them).
Y is any of the leaving groups usually employed by those skilled in the art as common leaving groups for nucleophilic substitution reactions. Preferred groups for the process reported in Scheme 2 are: F, Cl, Br, I, OH, OAc, C₁-C₂₀ alkanesulfonate, benzenesulfonate and mono- or poly-substituted arylsulfonates (expressly including substitution with one or more of the following preferred groups: CH₃, NO₂, F, Cl, Br, I, O-Alkyl, or any combination of them).

The process of Scheme 1 involves heating (for example, at 100-150° C.) of compound I and II, in stoichiometric ratio I/II included in the range 0.1-10, as such or suspended or dissolved in a suitable solvent, (for example xylene) for a period of time of 1-24 h, optionally in the presence or not of an acid catalyst selected from strong protic acids (preferred are sulphuric acid, nitric acid, hydrochloric acid, hydrobromic acid, hydriodic acid, trifluoroacetic acid, C₁-C₂₀ alkansulfonic acid, benzenesulfonic acid and mono- or poly-substituted arylsulfonic acid (expressly including substitution with one or more of the following preferred groups: CH₃, NO₂, F, Cl, Br, I, O-Alkyl, or any combination of them), Lewis acids, zeolites, acidic ion-exchange resins. Microwaves and/or ultrasounds may be used for increasing yields and reducing reaction times.

The process of Scheme 2 involves heating of compound I and IV, in stoichiometric ratio I/IV included in the range 0.1-10, as such or suspended or dissolved in a suitable solvent for a period of time of 1-24 h, optionally in the presence of an acid catalyst selected from strong protic acids (preferred are sulphuric acid, nitric acid, hydrochloric acid, hydrobromic acid, hydriodic acid, trifluoroacetic acid, C₁-C₂₀ alkanesulfonic acid, benzenesulfonic acid and mono- or poly-substituted arylsulfonic acid (expressly including substitution with one or more of the following preferred groups: CH₃, NO₂, F, Cl, Br, I, O-Alkyl, or any combination of them), Lewis acids, zeolites, acidic ion-exchange resins. Microwaves and/or ultrasounds may be used for increasing yields and reducing reaction times.

Conversion of compound V to compound III is performed by treating V with common systems employed for anion methathesis. The conversion is best performed by precipitating III from its solutions by means of a second solution of a suitable salt of the anion X⁻, or by treating a solution or a suspension of V with anion exchange resins, or flowing a solution of V through an ion exchange resin charged column and then eluting the desired compound III, or by partitioning a solution of V with a second solution of the desired anion X⁻, the latter solution being partially miscible with the first one and leading to the extraction of III into one of the two solutions. Recovery of compound III is performed evaporating or freeze-drying the corresponding solutions or precipitating III by addition of a suitable low-polarity solvent.

Typical examples of preparation of compounds of general formula V may be found in the following references:

### 1) JOC 1985, 1087

2) J. Phys. Org. Chem. 2005, 962

### 3) ICA 2003, 35, 39

The process is applicable to other onium salts described herein.

Hydrophobically modified onium cations may be obtained by applying the above process starting with a suitable commercially available precursor compound II or IV; for example commercially available (CF₃)₂Bn-Br.

In accordance with a fourth aspect of the present invention there is provided a coated ready-for-imaging lithographic precursor, the coating thereof being formed by application of a composition as claimed in any preceding claim, onto a lithographic substrate. Preferably the composition is applied as a solution in a solvent, and dried to form the coating. Preferably it is applied in one pass, and dries to form a homogenous dried coating. However it is not excluded that it be applied in one pass, and dry to form a inhomogenous dried coating, with segregation of components; or applied in two or more passes.

In accordance with a fifth aspect there is provided a method of making a precursor of the second aspect.

We have found it of benefit to give the precursors a heat treatment as part of their manufacture. Stabilising heat treatments for precursors are known per se. WO 99/21715 describes a heat treatment in which the printing form precursors, in a coil or stack, are given a heat treatment at a moderate temperature, for example 40-90° C., for an extended period, for example at least 4 hours. However a problem exists, in that poor properties may be found adjacent to the extremities of the stack or coil, for example at the top or bottom, and at edge regions.

EP 1074889A suggested carrying out a similar heat treatment, but under conditions which inhibit the removal of moisture from the precursor during the heat treatment. This optimises the properties of the precursor over a greater area. It is mentioned in EP 1074889A that this may entail carrying out the heat treatment step in an oven which provides an atmosphere whose relative humidity is at least 25%, or whose absolute humidity is at least 0.028. It is mentioned that it is preferred to carry out the heat treatment at a temperature of at least 40° C.

Whilst the method of EP 1074889A is believed to be effective, it does require careful and reliable process control and carries a significant capital cost.

We have devised an alternative heat treatment, also effective, and simple to apply, which is effective, with precursors in accordance with the present invention. Thus, preferably a precursor in accordance with the fourth aspect undergoes, as part of its manufacture, a heat treatment comprising:
a first phase, in which the precursor is exposed to a temperature at or exceeding a reference temperature and to relative humidity which does not exceed, 20% and/or to absolute humidity which does not exceed 0.025; and
a second phase, subsequent to the first phase, in which the precursor is exposed to a temperature which is less than the reference temperature and to relative humidity of at least 30% and/or to absolute humidity of at least 0.032.

Relative humidity as defined herein is the amount of water vapour present in air expressed as a percentage of the amount required for saturation at the same temperature. Absolute humidity as defined herein is the ratio between the mass of water vapour to the mass of air in a water-vapour air mixture.

Preferably the reference temperature is in the range 35-50° C., for example 35° C., 45° C., 50° C. or, preferably, 40° C.

Preferably the first phase lasts at least 4 hours, preferably at least 8 hours, preferably at least 12 hours, most preferably at least 24 hours. Preferably the precursor is exposed to a temperature at or exceeding a reference temperature and to the defined humidity conditions throughout the first phase.

Preferably the temperature during the first phase may reach 35-70° C., preferably 45-65° C., most preferably 50-60° C.; in any event preferably above the reference temperature. To bring the first phase to an end the temperature is preferably brought to the reference temperature. This may be brought about by the simple expedient of turning off the heat supply. The oven in which the precursor is located will be well insulated and it may take at least 1 hour for the temperature in the oven to fall from temperature within a preferred, elevated range, to the reference temperature, which is the transition point between the first phase and the second phase.

During the first phase the temperature is preferably within the range 35-70° C., preferably 50-65° C., and preferably within the most preferred range of 50-60° C., for at least 50%, and preferably at least 70%, of the duration of the first phase i.e. the time period in which it is at a temperature of at least the reference temperature.

When we refer to temperature herein we refer to the equilibrated temperature of a precursor or of a precursor stack or coil. In the case of a stack or coil the equilibrated temperature is achieved once a thermocouple located at the centre region of the stack or coil reaches a steady state temperature, equal to the oven temperature or the temperature of peripheral regions of the stack or coil. This may also be assessed by means of a thermocouple in the central region of the stack or coil.

During the first phase preferably no control of humidity is effected; or humidity is controlled to a maximum value of relative humidity of 20% and/or to a maximum value of absolute humidity of 0.025.

In certain environments relative humidity is controlled in the first phase to a maximum value of 15%, suitably to, maximum value of 10%, suitably to a maximum value of 5%.

In certain environments relative humidity is controlled in the first phase to a minimum value of 5%, suitably to a minimum value of 10%, suitably to a minimum value of 15%.

In certain environments absolute humidity is controlled in the first phase to a maximum value of 0.015, suitably to a maximum value of 0.01, suitably to a maximum value of 0.005.

In certain environments absolute humidity is controlled in the first phase to a minimum value of 0.005, suitably to a minimum value of 0.01, suitably to a minimum value of 0.015.

Preferably substantially at the commencement of the second phase, the humidity level is raised. The relative humidity is controlled to be at least 30%, preferably at least 35%, and most preferably at least 38%. Preferably the relative humidity is controlled to be not greater than 100%, preferably not greater than 80%, preferably not greater than 60%, preferably not greater than 50%, and most preferably not greater than 42%.

Preferably the temperature is reduced during the second phase. The second phase commences as soon as the temperature drops below the reference temperature. In preferred embodiments the temperature is allowed to fall naturally as the temperature of the oven and its contents fall, the heat supply having been terminated; but air at a selected temperature can be delivered to give controlled cooling, if wished. This may be useful in particular if the ambient temperature is high relative to the reference temperature.

Preferably it takes at least 1 hour for the temperature to fall to ambient temperature in the second phase, preferably at least 2 hours, preferably at least 4 hours, more preferably at least 12 hours.

Preferably the duration of the second phase is at least 1 hour, preferably at least 2 hours, preferably at least 4 hours, more preferably at least 8 hours. It could be longer than the time taken to fall to ambient temperature, because the precursor could be subjected to controlled temperature conditions below the reference temperature, even after it has fallen to ambient temperature, or kept in the oven even after ambient temperature has been reached. Preferably, however, the precursor reaching ambient temperature marks the end of the heat treatment.

When there is a stack or precursors or a precursor coil, preferably the end of the heat treatment is reached when the stack or coil reaches ambient temperature, or when no part of the stack or coil is more than 10° C., or preferably more than 5° C., above ambient temperature.

Preferably the precursor is exposed to a temperature below the reference temperature and to the defined humidity conditions throughout the second phase.

At the end of the heat treatment the precursors can be removed, and packaged up for sale.

At the start of the heat treatment the temperature must be raised from ambient temperature. The time period from commencing at ambient temperature and reaching the reference temperature may be regarded as a preliminary phase. Once the reference temperature is reached, the first phase commences.

Preferably the humidity is controlled throughout the second phase.

Preferably a stack of precursors is subject to the heat treatment at the same time. The stack suitably comprises at least 100, and commonly at least 500 precursors which undergo the heat treatment.

Alternatively a precursor coil may, with some coatings, be heated treated and cut into individual precursors later. Typically such a coil has at least 2,000 m² of imagable surface.

Whereas the invention of EP 1074398A involves the control of humidity throughout the whole heat treatment process we have realised that this is not necessary. The major part of the heat treatment, which part we call the first phase, can be carried out in a perfectly ordinary way, without any control, or with control of relative humidity up to 20% and/or absolute humidity up to 0.025. Wrapping to serve as a moisture barrier is not needed and preferably is not effected. If wrapping is effected it is preferably not a moisture barrier but simply a barrier to dirt. It is reasonable to expect that there will be some loss of moisture in edge regions of e.g. a stack or coil. However the control of humidity during the second phase appears to have a fully restorative effect. The properties of the precursors given a heat treatment in this way are excellent. We believe, without being bound by theory, that whilst there may be a dehydrating effect in the first phase in peripheral or exposed regions, the second phase brings about re-hydration.

In accordance with a sixth aspect of the present invention there is provided a ready-for-printing lithographic printing form precursor, or a ready-for-etching or ready-for-doping electronic part precursor, derived from imaging a lithographic printing form precursor or an electronic part precursor in accordance with the second aspect, to form a latent image in the coating and developing the image, the resulting imaged printing form or electronic part precursor having a desired pattern of residual coating. Preferably the printing form or electronic part precursor is developed using a developer, after imaging.

In accordance with a seventh aspect of the invention there is provided a method of making a lithographic printing form or electronic part precursor of the fifth aspect.

In accordance with an eighth seventh aspect of the present invention there is provided the use in printing of a lithographic printing form precursor, or use in electronic part manufacture of an electronic part precursor, in each case being a lithographic substrate bearing an to-be-imaged coating, the coating being formed by application and drying on the lithographic substrate of a liquid composition comprising a polymer, the composition being suitable as a coating for an IR-imagable lithographic precursor, the composition comprising one or more agent which:

a) absorbs IR radiation of wavelength greater than 800 nm and consequently generates heat;
b) functions as an insolubiliser which inhibits dissolution of non-imaged regions of the coating in a developer but permits dissolution of imaged regions;
c) improves the inhibition to dissolution of the non-imaged regions and/or the dissolution of the imaged regions so as to improve the dissolution ratio of the non-imaged/imaged regions; wherein the agent c) comprises a moiety which has hydrophobic and ionic character; the lithographic precursor being subjected to imagewise-delivered IR radiation of wavelength greater than 800 nm, then to a step of selectively removing in a developer either the regions which received radiation or those which did not receive radiation; then to an application or processing step; the application or processing step in the case of a lithographic printing form precursor being the supply of printing ink which gathers either at the removed regions or the non-removed regions; the application or processing step in the case of an electronic part precursor being an etching or doping step.

In accordance with a ninth aspect of the present invention there is provided the use in an imagable coating comprising a polymer, of an one or more agent(s) which

a) absorbs IR radiation of wavelength greater than 800 nm and consequently generates heat;
b) functions as an insolubiliser which inhibits dissolution of non-imaged regions of the coating in a developer but permits dissolution of imaged regions; and
c) improves the inhibition to dissolution of the non-imaged regions and/or the dissolution of the imaged regions so as to improve the dissolution ratio of the non-imaged/imaged regions; wherein the agent c) comprises a moiety which has hydrophobic and ionic character.

A preferred developer for use in any aspect herein is an aqueous developer liquid, preferably an aqueous alkaline' developer liquid. Preferred aqueous alkaline developer liquids include solutions of sodium metasilicate or of potassium metasilicate or of mixed sodium/potassium metasilicates. Suitably the sodium and/or potassium metasilicates constitute 5-20% w/w of the developer liquid, preferably 8-15% w/w. In a mixed sodium/potassium metasilicate solution sodium metasilicate is preferably in excess (by w/w) over potassium metasilicate, the ratio thereof preferably being in the range 1.5-2.5 (w/w), most preferably 1.8-2.2.

According to need, surfactants may be added to the compositions so as to obtain characteristics required by the printing plate. Surfactants are employed in order to enhance the coating application to aluminium or polyester supports. Surfactants which can be employed include fluorocarbonated surfactants such as FC-430 by 3M Corporation or Zonyl Ns by DuPont, block polymers of ethylene oxide and propylene oxide known as Pluronic and manufactured by BASF, and polysiloxane surfactants such as BYK 377 manufactured by BYK Chemie. These surfactants improve the coating composition cosmetics during application to the substrate, avoiding imperfections and the appearance of voids on the layer. The amount of surfactant employed ranges from 0.01 to 0.5% by weight base on the total weight of solids in the composition.

Preferred aqueous alkaline developer liquids for use herein contain a betaine surfactant, preferably in an amount constituting 0.05-2% w/w of the developer liquid, more preferably 0.2-1% (active betaine content). Betaine surfactants are compounds having a cationic functional group such as an ammonium or phosphonium ion, or other onium ion, and a negatively charged functional group such as a carboxyl group. Preferred betaines for use herein have a fatty alkyl chain. Preferred betaines for use herein are water soluble compounds having the general formula:

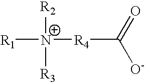

wherein R₁ is an alkyl group having 10 to 20 carbon atoms, preferably 12 to 16 carbon atoms, or the amido radical:

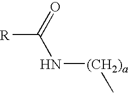

wherein R is an alkyl group having 9 to 19 carbon atoms and a is the integer 1 to 4; R₂ and R₃ are each alkyl groups having 1 to 3 carbons and preferably 1 carbon; R₄ is an alkylene or hydroxyalkylene group having from 1 to 4 carbon atoms and, optionally, one hydroxyl group. Alkyldimethyl betaines include decyl dimethyl betaine, 2-(N-decyl-N,N-dimethyl-ammonia) acetate, coco dimethyl betaine, 2-(N-coco N,N-dimethylammonio) acetate, myristyl dimethyl betaine, palmityl dimethyl betaine, lauryl dimethyl betaine, cetyl dimethyl betaine and stearyl dimethyl betaine and the like. Amidobetaines include cocoamidoethylbetaine, cocoamidopropyl betaine, coco (C₈-C₁₈) amidopropyl dimethyl betaine and the like.

Preferred aqueous alkaline developers for use herein contain an phosphate ester, preferably in an amount constituting 0.2-5% w/w of the developer liquid, preferably 0.2-2%, especially 0.3-1% (active phosphate ester content). Preferred phosphate esters include alkali metal phosphates of aromatic ethoxylates suitably those known as phosphate esters, aromatic ethoxylate, potassium salt, for example sold as RHODAFAC H66 from Rhodia.

Preferred aqueous alkaline developer liquids for use herein contain a sequestering agent, especially a sequestering agent which sequesters aluminium ions, preferably in an amount constituting 0.1-5% w/w, preferably 0.2-2% w/w, especially 0.3-1% w/w (active content of sequestering agent). Suitable sequestering agents include phosphonic acids and phosphonates, for example the sodium salt pentaethylenehexamineoctakis-(methylene phosphonic acid).

An especially preferred aqueous alkaline developer liquid for use in relation to the present invention consists essentially of 7-9% sodium metasilicate, 3.5-4.5% potassium metasilicate, 0.2-1% betaine surfactant, 0.2-1% phosphate ester and 0.2-1% sequestering agent, in water (active contents stated).

Definitions given above apply to all aspects of the present invention unless stated otherwise or unless the context does not permit them to.

The invention will now be further described by way of example with reference to the following examples.

### EXAMPLE SET 1

The following compounds were used as DCR improvers in the compositions tested in Example Set 1:

| DCR improver | Cation | Anion |
|---|---|---|
| MS1 | BnPh₃P⁺ | PF₆⁻ |
| MS2 | BnPh₃P⁺ | CF₃(CF₂)₇SO₃⁻ |
| MS3 | BnPh₃P⁺ | CF₃(CF₂)₅SO₃⁻ |
| MS4 | BnPh₃P⁺ | CF₃(CF₂)₃SO₃⁻ |
| MS5 | BnPh₃P⁺ | CF₃CF₂CO₂⁻ |
| MS6 | BnPh₃P⁺ | p-toluene sulfonate |
| MS7 | BnPh₃P⁺ | CH₃(CH₂)₁₁SO₃⁻ |
| MS8 | BnPh₃P⁺ | CH₃(CH₂)₂₀CO₂⁻ |
| MS9 | Ph₂I⁺ | CF₃(CF₂)₇SO₃⁻ |
| MS10 | m,m-(CF₃)₂BnPh₃P⁺ | PF₆ |
| MS11 | m,m-(CF₃)₂BnPh₃P⁺ | CF₃(CF₂)₇SO₃⁻ |
| MS12 | BnPh₃P⁺ | (CH₃)₃Si(CH₂)₃SO₃⁻ |
| MS13 | Crystal violet | CF₃(CF₂)₇SO₃⁻ |
| MS14 | Crystal violet | CF₃CF₂CO₂⁻ |
| MS15 | Crystal violet | CF₃CO₂⁻ |

Compositions were as follows (expressed in parts by weight):

| Comp'n | AS0 | AS1 | AS2 | AS3 | AS4 | AS5 | AS6 | AS7 | AS10 |
|---|---|---|---|---|---|---|---|---|---|
| EP3525 | 42.4 | 42.4 | 42.4 | 42.4 | 42.4 | 42.4 | 42.4 | 42.4 | 42.4 |
| LB744 | 54 | 54 | 54 | 54 | 54 | 54 | 54 | 54 | 54 |
| S0094 | 1 | 1 | 1 | 1 | 1 | 1 | 1 | 1 | 1 |
| S0253 | 0.6 | 0.6 | 0.6 | 0.6 | 0.6 | 0.6 | 0.6 | 0.6 | 0.6 |
| MS | 0 | 2 | 2 | 2 | 2 | 2 | 2 | 2 | 2 |
| compd | | | | | | | | | |
| CV | 2 | 2 | 2 | 2 | 2 | 2 | 2 | 2 | 2 |
| Total | 100 | 102 | 102 | 102 | 102 | 102 | 102 | 102 | 102 |

AS1, 2 . . . 10 respectively contain as DCR improver MS1, 2 . . . 10. AS0 and AS1 are comparative examples.

EP 3525 is a novolac resin available from Asahi, Japan and distributed by DKSH France S.A.

LB 744 is a cresol novolac resin available from Hexion Speciality Chemical GmbH, of Germany.

S0094 is an IR absorbing cyanine dye available from Few Chemical GmbH, of Germany.

S0254 is an IR absorbing cyanine dye available from Few Chemical.

CV is crystal violet IR dye, also known as Methyl Violet 10B, having a tris(dimethylaminophenyl)methane cation and a chloride anion, and is available as Siber Violet from DKSH, France.

The compositions were made up in a solvent Dowanol PM (1-methoxy-2-propanol)/methyl ethyl ketone (90/10 wt/wt mixture) at a concentration of composition in solvent of approximately 15/100 wt/wt). The compositions were coated onto a lithographic substrate, an example of which was prepared from lithographic grade 1050A Aluminium by 1) degreasing in Sodium Hydroxide solution (24 g/l) at 40° C. for 20 seconds followed by rinsing 2) Electrochemical etching in a mixture of Acetic (13 g/l) and Hydrochloric (7 g/l)Acids at 30° C. for 40 seconds followed by rinsing 3) Desmutting the etched metal in Phosphoric acid (240 g/l) at 54° C. for 20 seconds followed by rinsing 4) Anodising in Sulphuric Acid (240 g/l) at 32° C. for 40 seconds followed by rinsing and 5) Treating the anodised substrate with a solution containing Monosodium Phosphate (44 g/l) and Sodium Fluoride (0.5 g/l) at 70° C. for 30 seconds followed by rinsing. An example of which was prepared by 1) using a wire wound bar from Mayer, bar number 2, supplied by Urai S.p.A., of Italy, and dried for 3 minutes at a′ temperature of 110° C. in oven (model No. 600 from Memmert GmbH & Co., of Germany). The coating weight after drying was approximately 1.5 gm'.

The coated test substrates where tested for their imaging properties within 8 hours of being coated. The coated test substrates were imaged using a Plate Rite 4100 machine supplied by Dainippon Screen Mfg. Co. Ltd., of Japan, using the 700 rpm setting and a wavelength of approximately 808 nm. They were developed immediately after being imaged, in a commercially available developer GOLDSTAR (Trade Mark of Kodak Polychrome Graphics), in a Sirio 85 processor, supplied by O.V.I.T., of Italy, at an 85 mS/cm developer activity value.

For comparison purposes the tests included benchmark commercial printing plate ELECTRA (Trade Mark of Kodak Polychrome Graphics)—old (12 months old) and new (3 months old) samples, whose composition in each case is believed to be in accordance with EP 825927B.

The test substrates and the ELECTRA products were then tested for three properties, as follows:

Coating loss: on development, using a densitometer (Model: VIPLATE 115 VIPTRONIC. Supplier: Tecnologie Grafiche, of Italy. A circle is drawn on a non-image portion of the plate and the density reading is taken and recorded—this is referred to as D-initial. After exposure and development the same area is re-measured (D-final) and the difference between the D-initial and the D-final is calculated and recorded—this figure is referred to as ×, or “Delta”. In practice this is carried out three times per sample and an average used to minimise experimental error. The density of clean substrate on the plate is also recorded as D-subs. The percentage coating lost is now given by

$$\frac{( D \text{-} initial \text{-} D \text{-} final )}{( D \text{-} initial \text{-} D \text{-} subs )} \times 100 = Δ \%$$

In practice development time, temperature or developer strength may vary and this test is an indication of how robust the coating is to more aggressive development conditions. The actual values depend on the formulation composition especially the choice of resin mix but in all cases the lower the Δ% the better.

Optical point: From a power series exposure (e.g. 40% power increasing in 5% increments to 100% power at 808 rpm) this is the energy at which groups of parallel lines of differing widths (tens of micrometres range) appear to have the same density by eye. At exposure energies higher than this the finer lines appear darker than the optical point whilst at exposure energies below the optical point the wider lines appear darker. At this point a 50% chequerboard should read approximately 48%. The value is simply read from the exposed and processed plate by eye using a magnifying glass.

Clear point: The clear point is also read from a power series exposure test (see above) but in this case it is the areas that are intended to contain 0% dots (fully exposed) that are evaluated. At low energies coating has not received sufficient energy to fully expose and thus remain dark with undeveloped coating. At the optical point the substrate should be clear where clear is defined as having a density <0.01 density units higher than clean substrate. The clear point is the lowest exposure energy that yields a background density of <0.01 units and should be at least 25% of power lower than the optical point. This is referred to as the Density Clear Point (DCP). The clear point is important in practice so that the plate can accommodate variations in developer time, temperature and developer strength that are less aggressive than usual. The lower the value the more robust the plate. An alternative, more subjective method is to put a drop of acetone onto a 100% exposure then developed patch and look for a coloured ring due to any remaining residues. This Visual Clear Point (VCP) is the lowest energy where a solvent induced ring is not visible. This method is more subjective due to an individual's eye receptivity and ‘threshold’ and also lighting.

Ideally the clear point is determined numerically using a densitometer (DCP), however, in some circumstances such as on large format plates or where there is cross web substrate unevenness the variation of substrate density can be sufficiently large to mask the level of residual coating or stain. Under these conditions the more subjective Visual Clear Point (VCP) method is employed.

Results were as follows.

| | | | Clear point |
|---|---|---|---|
| Sample | Optical point | Δ (%) | (DCP)/% |
| Electra (old) | 100 | 5.4 | 70 |
| Electra (new) | 90 | 6.30 | 50 |
| AS0 | 85 | 7.1 | 45 |
| AS1 | 100 | 5.2 | 80 |
| AS2 | 92.5 | 4.5 | 65 |
| AS3 | 90 | 5.1 | 60 |
| AS4 | 100 | 4.3 | 65 |
| AS5 | 92.5 | 4.4 | 70 |
| AS6 | 100 | 4.1 | 70 |
| AS7 | 97.5 | 3.6 | 67.5 |
| AS10 | 95 | 6 | 65 |

The Electra examples, AS0 and AS1 are present for comparison purposes, not as part of the invention. AS0 is unacceptable in Δ% showing image damage after development but the clear and optical points are good. When we add an inhibitor AS1 to improve the developer resistance 15% of optical point energy and 35% of clear point energy is lost.

It is seen that by use of the compounds MS2-M510 in samples AS2-AS10 we obtained excellent selectivity as regards dissolution rates in developer, as between the imaged, soluble, and non-imaged, developer resistant, areas; whilst the energy needed to achieve this differentiation (or “operating speed”) is not compromised.

### EXAMPLE SET 2

In Example Set 2 benzyltriphenylphosphonium 3-trimethylsilylpropyl-1-sulfonate (MS12) and crystal violet perfluorooctyl-1-sulfonate (MS13) were evaluated as possible DCR improvers. These were again coated from a 15% solution of a 90:10 mixture of Dowanol PM and MEK to produce a film weight of approximately 1.5 gm⁻². Examples BS1 to BS4 were dried at 130° C. for 3 minutes and examples BS5 to BS10 were dried at 110° C. for 3 minutes.

Compositions tested were as follows (expressed in parts by weight):

| Comp'n | BS1 | BS2 | BS3 | BS4 | BS5 | BS6 | BS7 | BS8 | BS9 | BS10 |
|---|---|---|---|---|---|---|---|---|---|---|
| EP4050 | 2.174 | 2.174 | 2.174 | 2.174 | 2.191 | 2.191 | 2.191 | 2.191 | 2.191 | 2.191 |
| FB 636 | 0.040 | 0.040 | 0.040 | 0.040 | 0 | 0 | 0 | 0 | 0 | 0 |
| Crystal Violet | 0 | 0 | 0 | 0 | 0.045 | 0 | 0 | 0 | 0 | 0 |
| S0094 | 0.023 | 0.023 | 0.023 | 0.023 | 0.023 | 0.023 | 0.023 | 0.023 | 0.023 | 0.023 |
| S0253 | 0.014 | 0.014 | 0.014 | 0.014 | 0.014 | 0.014 | 0.014 | 0.014 | 0.014 | 0.014 |
| MS1 | 0 | 0.045 | 0 | 0 | 0.023 | 0.023 | 0.023 | 0.023 | 0.023 | 0.023 |
| MS12 | 0 | 0 | 0.045 | 0.09 | 0 | 0 | 0 | 0 | 0 | 0 |
| MS13 | 0 | 0 | 0 | 0 | 0 | 0.011 | 0.023 | 0.045 | 0.068 | 0.090 |
| Total | 2.251 | 2.296 | 2.296 | 2.341 | 2.296 | 2.307 | 2.319 | 2.341 | 2.364 | 2.386 |

Imaging, development and testing was carried out as described above for Example Set 1.

BS1, BS2 and BS5 are comparative examples, not of the invention.

Results were as follows.

| | Optical | | Clear point | Clear point |
|---|---|---|---|---|
| Sample | point/% | Δ (%) | (DCP)/% | (VCP)/% |
| BS1 | NM | 8.1 | 45 | 50 |
| BS2 | 85 | 4.1 | 55 | 80 |
| BS3 | 85 | 6.0 | 55 | 70 |
| BS4 | 95 | 6.4 | 60 | 80 |
| BS5 | 90 | 5.7 | 60 | >100 |
| BS6 | NM | 7.3 | <40 | <40 |
| BS7 | 72.5 | 6.7 | <40 | 45 |
| BS8 | 80 | 6.4 | <40 | 45 |
| BS9 | 80 | 6.3 | 45 | 60 |
| BS10 | 80 | 5.8 | 45 | 65 |

NM means not measurable.

The first example BS1 contains no onium inhibitor and has very poor developer resistance, BS2 contains MS1 as an onium inhibitor that does not contain an hydrophobic moiety. BS3 and BS4 contain 2 and 3% of MS12 respectively in place of MS1. We can observe a clear point, measured visually, at the 2% MS12 level which requires 10% less energy to clear the background than when using MS1 at the same level, without compromise to the speed.

BS5 is a reference sample for the modified crystal violet onium MS13 and has crystal violet at a level of approximately 2% by weight of solids. BS6 to BS10 have no crystal violet and have 0.5, 1.0, 2.0, 3.0 and 4.0% MS13 in its place respectively. Since the molecular weight of MS13 is significantly higher than crystal violet the tinctorial strength equivalent of BS5 is BS10. We can observe that for the same developer resistance (Δ%) MS10 clears at 15% less energy and requires 10% less energy to achieve the optical point.

### EXAMPLE SET 3

In Example Set 3 comparison was made between a composition containing crystal violet (CV) as insolubiliser with DCR improver present; and a composition in which the standard crystal violet was replaced by crystal violet modified with the intention of acting as a DCR improver (MS14). The modified crystal violet (MS14) had the usual tris(dimethylamino-phenyl)methane crystal violet cation but instead of a chloride anion, had the anion CF₃CF₂CO₂⁻.

Compositions tested were as follows (expressed in parts by weight):

| Comp'n | CS1 | CS2 | CS3 | CS4 | CS5 | CS6 | CS7 | CS8 |
|---|---|---|---|---|---|---|---|---|
| EP4050 | 97.4 | 96.4 | 95.4 | 94.4 | 97.4 | 96.4 | 95.4 | 94.4 |
| S0094 | 1 | 1 | 1 | 1 | 1 | 1 | 1 | 1 |
| S0253 | 0.6 | 0.6 | 0.6 | 0.6 | 0.6 | 0.6 | 0.6 | 0.6 |
| CV | 1 | 2 | 3 | 4 | 0 | 0 | 0 | 0 |
| MS14 | 0 | 0 | 0 | 0 | 1 | 2 | 3 | 4 |
| Total | 100 | 100 | 100 | 100 | 100 | 100 | 100 | 100 |

CS1-4 are present for comparison purposes, not as part of the invention.

Imaging, development and testing was carried out as described above for Example Set 1.

Results were as follows.

| | | | Clear point |
|---|---|---|---|
| Sample | Optical point | Δ (%) | (DCP/%) |
| CS1 | 90 | 11.5 | 55 |
| CS2 | 92.5 | 7.9 | 80 |
| CS3 | >100 | 4 | NM |
| CS4 | >100 | 1.5 | NM |
| CS5 | 85 | 8.9 | 45 |
| CS6 | 90 | 7.1 | 75 |
| CS7 | 95 | 5.25 | 75 |
| CS8 | 100 | 4.9 | 90 |

NM means not measurable.

Although the examples CS1-4 containing unmodified crystal violet alone gave very good weight loss values at 3 and 4% of CV it was at the expense of poor optical point values: and unmeasurable clear point values. In contrast in the examples CS5-8 containing the modified crystal violet gave-good all round performance in these tests.

### EXAMPLE SET 4

In Example Set 4 some of the above DCR improvers were evaluated in compositions which were given a stabilising or “tempering” heat treatment. The DCR improvers selected were MS2, MS3, MS4 and MS5. MS1 was also tested as a comparison. The amounts of DCR improver were adjusted to give molar equivalence.

Compositions employed were as follows (expressed in parts by weight):

| Comp'n | DS1 | DS2 | DS3 | DS4 | DS5 |
|---|---|---|---|---|---|
| LB744 | 66.0 | 65.6 | 65.7 | 65.8 | 66.0 |
| EP3525 | 27.4 | 27.1 | 27.2 | 27.3 | 27.4 |
| S0094 | 1 | 1 | 1 | 1 | 1 |
| S0253 | 0.6 | 0.6 | 0.6 | 0.6 | 0.6 |
| CV | 2 | 2 | 2 | 2 | 2 |
| CAHPh | 2 | 2 | 2 | 2 | 2 |
| MS1 | 1 | | | | |
| MS2 | | 1.7 | | | |
| MS3 | | | 1.5 | | |
| MS4 | | | | 1.3 | |
| MS5 | | | | | 1.0 |
| Total | 100 | 100 | 100 | 100 | 100 |

CAHPh is cellulose acetate hydrogen phthalate

Imaging, development and testing was carried out as described above for Example Set 1, except that a conditioning heat treatment was carried out. The lithographic plates were laid in a stack, separated from each other by paper interleaving (non-coated, paper weight of 40 gm⁻²), wrapped in the same paper, and placed in a conditioning oven at 55° C. at a relative humidity (RH) of 40%, for 96 hours.

Results were as follows.

| | | | Clear point |
|---|---|---|---|
| Sample | Optical point | Δ (%) | (DCP)/% |
| DS1 | 90 | 3.2 | 65 |
| DS2 | 90 | 0.95 | 60 |
| DS3 | 87.5 | 1.7 | 60 |
| DS4 | 90 | 1.9 | 55 |
| DS5 | 90 | 2.7 | 60 |

With DS1 as the reference onium that does not contain the hydrophobic moiety we can see significant improvements in both clear points and developer resistance (Δ%) without compromising the sensitivity of the plate.

### EXAMPLE SET 5

In Example Set 5 Delta values of different samples were evaluated. The samples were prepared as described in Example Set 1 and their compositions were as follows:

| | ES1 | ES2 |
|---|---|---|
| LB744 | 74.00 | 59.50 |
| EP3525 | 21.40 | 34.40 |
| CAHPh | 1.00 | 1.00 |
| MS1 | 0.00 | 0.00 |
| MS2 | 0.00 | 1.50 |
| S0254 | 0.60 | 0.60 |
| S0094 | 1.00 | 1.00 |
| CV | 2.00 | 2.00 |

ES2 is in accordance with the present invention.

The samples were given a “tempering” heat treatment as described in Example Set 4.

The developer was a self-made developer formulated from a developer SLT900 supplied commercially by Recordgraph S.R.L. of Bologna, Italy, containing 10-20% w/w sodium metasilicate and 1-3% w/w sodium silicate, in water (98% w/w) and Lunasperse (trade mark) available from American Dye Source, Inc., of Quebec, Canada or from DKSH Italy S.R.L. of Milan, Italy (2% w/w). Lunasperse is believed to have 20% w/w content of the betaine actives, a mixture of mono- and di-alkyl ethoxylated amine acetic acid betaine salts, in water.

Delta values obtained were as follows:

| | Δ % |
|---|---|
| ES1 | 21.27 |
| ES2 | 5.36 |

### EXAMPLE SET 6

In Example Set 6 some of the above DCR improvers were evaluated in compositions which were given an alternative, simpler, “tempering” heat treatment in which there was a first phase in which the humidity was low—either 20% RH or uncontrolled humidity (which in practice generally means less than 5% RH); followed by a second, cooling, phase in which humidity was higher, at 30% RH.

The coating composition was applied in the manner described in Example Set 1 to a substrate as described in Example Set 1, and dried as described in Example Set 1.

The composition was as follows (herewith called FS0):

| | FSO |
|---|---|
| LB744 | 49.00 |
| EP3525 | 43.90 |
| CAHPh | 1.00 |
| MS1 | 1.00 |
| MS2 | 1.50 |
| S0254 | 0.60 |
| S0094 | 1.00 |
| CV | 2.00 |

Samples FS1, FS2 and FS3 underwent different heat treatment regimes, using 40° C. as the aforementioned “reference temperature” in the case of FS1 as follows:

| Sample | First phase | Second phase |
|---|---|---|
| FS1 | 55° C. at RH 20%, 72 hrs | Allow to cool to ambient. |
| | | At 40° C. and below RH was |
| | | 40% |
| FS2 | 55° C. at RH 40%, 72 hrs | Allow to cool to ambient, |
| | | RH not controlled |
| FS3 | 55° C., 72 hrs, RH not | Allow to cool to ambient, |
| | controlled, | RH not controlled |

The resulting samples were imaged as described above for Example Set 1, and developed using the developer described in Example Set 5. The samples were found to give the following Delta values.

| FS1 | | | | | | | | | FS2 | | | | | | | | |
|---|---|---|---|---|---|---|---|---|---|---|---|---|---|---|---|---|---|
| LEFT | | | CENTRE | | | RIGHT | | | LEFT | | | CENTRE | | | RIGHT | | |
| 2.95 | 3.10 | 3.20 | 3.25 | 3.30 | 3.30 | 3.10 | 3.10 | 2.95 | 3.10 | 3.35 | 3.30 | 3.30 | 3.20 | 3.20 | 3.25 | 3.25 | 3.10 |
| 3.00 | 3.25 | 3.25 | 3.30 | 3.30 | 3.40 | 3.10 | 3.10 | 2.95 | 3.40 | 3.30 | 3.35 | 3.25 | 3.25 | 3.25 | 3.35 | 3.30 | 3.10 |
| 3.00 | 3.10 | 3.30 | 3.30 | 3.35 | 3.20 | 3.25 | 3.15 | 2.90 | 3.20 | 3.25 | 3.45 | 3.30 | 3.35 | 3.25 | 3.30 | 3.31 | 3.15 |
| 3.00 | 3.10 | 3.25 | 3.20 | 3.30 | 3.15 | 3.15 | 3.15 | 3.05 | 3.20 | 3.40 | 3.50 | 3.30 | 3.40 | 3.35 | 3.20 | 3.30 | 3.20 |
| 3.05 | 3.10 | 3.25 | 3.25 | 3.30 | 3.25 | 3.10 | 3.05 | 3.05 | 3.10 | 3.35 | 3.35 | 3.30 | 3.40 | 3.30 | 3.15 | 3.05 | 3.15 |
| 3.00 | 3.20 | 3.25 | 3.30 | 3.25 | 3.25 | 3.20 | 3.10 | 3.05 | 3.15 | 3.15 | 3.15 | 3.25 | 3.20 | 3.35 | 3.25 | 3.20 | 3.10 |
| 3.00 | 3.15 | 3.15 | 3.25 | 3.30 | 3.30 | 3.10 | 3.10 | 3.00 | 3.10 | 3.20 | 3.30 | 3.25 | 3.30 | 3.30 | 3.25 | 3.15 | 3.20 |
| 3.05 | 3.15 | 3.30 | 3.25 | 3.20 | 3.30 | 3.15 | 3.20 | 2.95 | 3.20 | 3.25 | 3.30 | 3.35 | 3.35 | 3.25 | 3.20 | 3.15 | 3.20 |
| 3.00 | 3.10 | 3.25 | 3.05 | 3.10 | 3.20 | 3.05 | 3.05 | 2.95 | 3.15 | 3.25 | 3.40 | 3.35 | 3.40 | 3.30 | 3.15 | 3.20 | 3.05 |
| 2.90 | 3.15 | 3.25 | 3.15 | 3.15 | 3.20 | 3.10 | 2.30 | 3.00 | 3.25 | 3.30 | 3.30 | 3.25 | 3.25 | 3.25 | 3.15 | 3.15 | 2.95 |

| FS3 | | | | | | | | |
|---|---|---|---|---|---|---|---|---|
| LEFT | | | CENTRE | | | RIGHT | | |
| 2.20 | 2.55 | 2.65 | 3.10 | 3.20 | 3.10 | 2.45 | 2.20 | 1.60 |
| 2.00 | 2.45 | 2.95 | 3.20 | 3.30 | 3.30 | 2.70 | 2.15 | 1.80 |
| 1.95 | 2.60 | 2.80 | 3.30 | 3.25 | 3.25 | 2.70 | 2.50 | 1.80 |
| 1.90 | 2.40 | 2.80 | 3.15 | 3.35 | 3.30 | 2.80 | 2.35 | 1.85 |
| 1.90 | 2.35 | 2.75 | 3.10 | 3.30 | 3.25 | 2.65 | 2.35 | 1.70 |
| 1.85 | 2.55 | 2.80 | 3.40 | 3.40 | 3.35 | 2.65 | 2.25 | 1.75 |
| 1.80 | 2.60 | 2.85 | 3.25 | 3.20 | 3.30 | 2.80 | 2.20 | 1.70 |
| 1.90 | 2.50 | 2.80 | 3.35 | 3.20 | 3.25 | 2.70 | 2.45 | 1.75 |
| 1.70 | 2.60 | 2.85 | 3.20 | 3.25 | 3.20 | 2.70 | 2.40 | 1.70 |
| 1.75 | 2.50 | 2.75 | 3.05 | 3.00 | 3.10 | 2.70 | 2.55 | 1.65 |

The results for both samples, FS1 and FS2, are acceptable across their entire surfaces, from one edge to the other. Fs3 is unacceptable in terms of edge behaviour and dot reproduction.

Example Set 7

Example Set 7 used the same composition as samples ES1 and ES2 of Example Set 5 and the same manufacturing conditions and processing conditions as Example Set 4, but used the following self-formulated experimental developer:

| | COMPOSITION |
|---|---|
| COMPONENTS | (% w/w) |
| Sodium metasilicate | 7.7 |
| Potassium metasilicate | 3.9 |
| Sequestering agent for Al(neutral, | 2.0 |
| aqueous solution of the sodium salt of | |
| pentaethylenehexamineoctakis(methylene | |
| phosphonic acid), 25% w/w active, CAS | |
| NO. 93892-82-1 | |
| Surfactant (fatty acid amido alkyl | 0.7 |
| betaine: TEGO betaine L7 (trade mark), | |
| 30% w/w active, CAS No. 61789-40-0) | |
| Surfactant (phosphate ester, aromatic | 1.2 |
| ethoxylate, potassium salt, 50% w/w | |
| active, CAS No. 66057-30-5) | |
| Water | to 100 |

This was used in comparison with the as supplied developer SLT 900 mentioned above, not containing a betaine surfactant.

Delta results were as follows:

| | | Δ % using |
|---|---|---|
| | Δ % using SLT 900 | experimental developer |
| GS1 (=ES1) | 37.98 | 17.32 |
| GS2 (=ES2) | 50.00 | 9.30 |

It will be observed that the Delta values using SLT900 are high in this Example Set, but much less when the experimental developer is used. One can further observe that using a developer that does not contain the betaine surfactant SLT900, there is no additional protection on the sample containing MS2 (GS2) compared to one that does not contain MS2 (GS1) and, in fact, the performance is worse. Using the betaine containing surfactant, the coatings have generally improved performance and the MS2-containing formulation, GS2, now has a superior performance compared to the non-MS2 containing formulation, GS1.

In all of the above example sets the results stated were the average of at least three results and were measured in a central region of a printing form precursor unless otherwise stated.

1. A composition comprising a polymer which contains hydroxyl groups, the composition being suitable as a coating for an IR-imagable lithographic precursor, the composition comprising one or more agent(s) which:
a) absorbs IR radiation of wavelength greater than 800 nm and consequently generates heat;
b) functions as an insolubiliser which inhibits dissolution of non-imaged regions of the coating in a developer but permits dissolution of imaged regions during development; and
c) improves the inhibition to dissolution of the non-imaged regions and/or the dissolution of the imaged regions so as to improve the dissolution contrast ratio (DCR) of the non-imaged/imaged regions; wherein the agent which performs function c) comprises a moiety which has hydrophobic and ionic character.

2. A composition as claimed in claim 1, in which the agent which functions as an insolubiliser does not decompose on absorption of the IR radiation.

3. A composition as claimed in claim 1, in which the agent absorbs IR radiation in the wavelength range 805 nm to 1500 nm, preferably 850 to 1250 nm.

4. A coated ready-for-imaging lithographic precursor, the coating thereof being formed by application of a composition as claimed in claim 1, onto a lithographic substrate.

5. A ready-for-printing lithographic printing form or ready-for-etching or ready-for-doping electronic part precursor, derived from imaging a precursor as claimed in claim 10 to form a latent image in the coating and developing the image, the resulting imaged printing form or electronic part precursor having a desired pattern of residual coating.

6. Use in printing of a lithographic printing form precursor, or use in electronic part manufacture of an electronic part precursor, in each case being a lithographic substrate bearing an to-be-imaged coating, the coating being formed by application and drying on the lithographic substrate of a liquid composition comprising a polymer which contains hydroxyl groups, the composition being suitable as a coating for an IR-imagable lithographic precursor, the composition comprising one or more agent which:
a) absorbs IR radiation of wavelength greater than 800 nm and consequently generates heat;
b) functions as an insolubiliser which inhibits dissolution of non-imaged regions of the coating in a developer but permits dissolution of imaged regions; and
c) improves the inhibition to dissolution of the non-imaged regions and/or the dissolution of the imaged regions so as to improve the dissolution ratio of the non-imaged/imaged regions; wherein the agent c) comprises a moiety which has hydrophobic and ionic character; the lithographic precursor being subjected to imagewise-delivered IR radiation of wavelength greater than 800 nm, then to a step of selectively removing in a developer either the regions which received radiation or those which did not receive radiation; then to an application or processing step; the application or processing step in the case of a lithographic printing form precursor being the supply of printing ink which gathers either at the removed regions or the non-removed regions; the application or processing step in the case of an electronic part precursor being an etching or doping step.

7. Use as claimed in claim 6 wherein the processing step employs an alkaline aqueous developer which includes a betaine surfactant.

8. Use in an imagable coating of a polymer which contains hydroxyl groups, and one or more agent(s) which
a) absorbs IR radiation of wavelength greater than 800 nm and consequently generates heat;
b) functions as an insolubiliser which inhibits dissolution of non-imaged regions of the coating in a developer but permits dissolution of imaged regions; and
c) improves the inhibition to dissolution of the non-imaged regions and/or the dissolution of the imaged regions so as to improve the dissolution ratio of the non-imaged/imaged regions; wherein the agent c) comprises a moiety which has hydrophobic and ionic character.

9. A method of making a lithographic precursor as claimed in claim 4, wherein as part of its manufacture it undergoes a heat treatment comprising a first phase, in which the precursor is exposed to a temperature at or exceeding a reference temperature and to relative humidity which does not exceed 20% and/or to absolute humidity which does not exceed 0.025; and
a second phase, subsequent to the first phase, in which the precursor is exposed to a temperature which is less than the reference temperature and to relative humidity of at least 30% and/or to absolute humidity of at least 0.032.

10. A salt whose cation is selected from at least one of hydrophobic alkyl, fluoroalkyl, hydrophobic silicon-containing group, and hydrophobic aryl which is optionally substituted by at least 1, 2 or 3 moieties selected from fluoro, alkyl, fluoroalkyl and silicon-containing group.

11. A salt whose anion is selected from at least one of hydrophobic alkyl group, hydrophobic silicon-containing group and hydrophobic aryl group which is optionally substituted by at least 1, 2 or 3 moieties selected from fluoro, alkyl, fluoroalkyl and silicon-containing group.

12. A salt of a phosphonium cation and of an alkyl- or aryl-carboxylate or sulphonate anion made hydrophobic by the presence of fluorine, silicon, fatty alkyl, or aryl moieties.

13. A salt of a triarylmethane cation and of a carboxylate or sulphonate anion made hydrophobic by the presence of fluorine, silicon, fatty alkyl, or aryl moieties.
